(19) United States
(12) Patent Application Publication
(10) Pub. No.: US 2019/0368538 A1
(43) Pub. Date: Dec. 5, 2019

(54) BALL JOINT WITH ELECTRONIC BRAKING

(71) Applicant: Curadel, LLC, Marlborough, MA (US)

(72) Inventors: John V. Frangioni, Weston, MA (US); Tammy Ann Gauthier, Litchfield, NH (US)

(73) Assignee: Curadel, LLC

(21) Appl. No.: 16/429,258

(22) Filed: Jun. 3, 2019

Related U.S. Application Data
(60) Provisional application No. 62/680,477, filed on Jun. 4, 2018.

(51) Int. Cl. F16C 11/10; F16D 63/00; F16C 11/06

(52) U.S. Cl. CPC F16C 11/10; F16D 63/002; F16D 2121/20; F16C 11/0609; F16C 2202/40; F16C 11/0623

(57) ABSTRACT

In one embodiment, a ball joint comprises a base that includes a first surface that defines a hemispherical chamber and an electromagnet located internal to the base. The ball joint further comprises an armature plate fastened to the first surface of the housing and defining an aperture that extends through the armature plate towards the hemispherical chamber. The ball joint further comprises a shaft that extends through the aperture of the armature plate and has a rounded end that engages the hemispherical chamber of the housing. Powering the electromagnet draws the armature plate towards the first surface to provide compressive force to the shaft and prevents movement of the shaft.

### RELATED APPLICATION

This application claims priority to U.S. Provisional Patent Application No. 62/680,477, filed on Jun. 4, 2018, entitled “BALL JOINT WITH ELECTRONIC BRAKING” by Frangioni, the contents of which are incorporated by reference herein.

### TECHNICAL FIELD

The present disclosure relates generally to ball joints and, more particularly, to a ball joint with electronic braking.

### BACKGROUND

Ball joints that provide three degrees of freedom can be used in a number of different applications, ranging from robotics, to vehicle suspensions, to other fields of use. For example, in one specific use case, a ball joint may be used as part of support arm for a medical imaging system, to control the position of the imaging system relative to a subject being imaged. Once the payload has been positioned, however, further movement of the ball joint must be prevented.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 shows an example cross sectional side view of a ball joint with an electronic brake;

FIG. 2 shows an example perspective side view of the ball joint of FIG. 1;

FIG. 3 shows another example cross sectional side view of the ball joint of FIG. 1;

FIG. 4 shows an example bottom view of the ball joint of FIG. 1;

FIG. 5 shows a schematic diagram of the ball joint of FIG. 1, to illustrate the electronic braking mechanism of the ball joint; and

FIG. 6 shows another schematic diagram of the ball joint of FIG. 1, to illustrate cable(s) extending through the ball joint.

In the figures, reference numbers refer to the same or equivalent parts of the present invention throughout the several figures of the drawing.

### SUMMARY

According to various embodiments, a ball joint is disclosed herein that comprises a base that includes a first surface that defines a hemispherical chamber and an electromagnet located internal to the base. The ball joint further comprises an armature plate fastened to the first surface of the housing and defining an aperture that extends through the armature plate towards the hemispherical chamber. The ball joint further comprises a shaft that extends through the aperture of the armature plate and has a rounded end that engages the hemispherical chamber of the housing. Powering the electromagnet draws the armature plate towards the first surface to provide compressive force to the shaft and prevents movement of the shaft.

### DETAILED DESCRIPTION

To provide an overall understanding of the invention, certain illustrative embodiments will now be described.

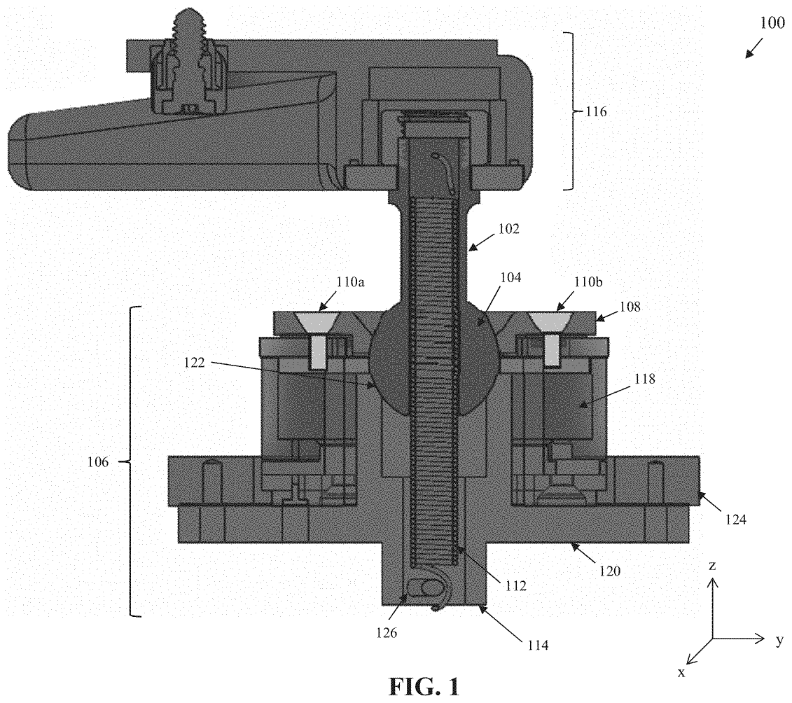

FIG. 1 shows an example cross sectional side view of a ball joint 100, according to various embodiments. As shown, ball joint 100 may generally include a shaft 102, a base 106, and an armature plate 108. In various embodiments, a payload device 116 to be positioned via ball joint 100 may be affixed to shaft 102 such as, e.g., via fasteners (e.g., bolts, screws, etc.), adhesive, a screw-in coupling, or other suitable fastening mechanism. For example, payload device 116 may be a mount, imaging device, actuator, or the like.

In various embodiments, base 106 may include a first, top surface that defines a chamber 122 and opposite a second, bottom surface 114 of base 106. For example, base 106 may include a housing 120 that may form chamber 122 and include a top plate 124 fastened to housing 120. In further embodiments, base 106 may be of a singular construction of any suitable material such as, but not limited to, plastics, metals, ceramics, or the like.

In various embodiments, shaft 102 may include a curved end 104 opposite that of payload device 116 and configured to engage chamber 122 of base 106. In general, curved end 104 may be of a substantially spherical or hemispherical shape, so as to act as a ball bearing within chamber 122. Similarly, chamber 122 may be of at least a hemispherical shape or otherwise curved to engage at least a portion of curved end 104 of shaft 102. In some cases, curved end 104 may be integrally formed with shaft 102 as a single component. However, further embodiments provide for curved end 104 to be formed separately from that of shaft 102 and affixed thereto using a suitable fastening means.

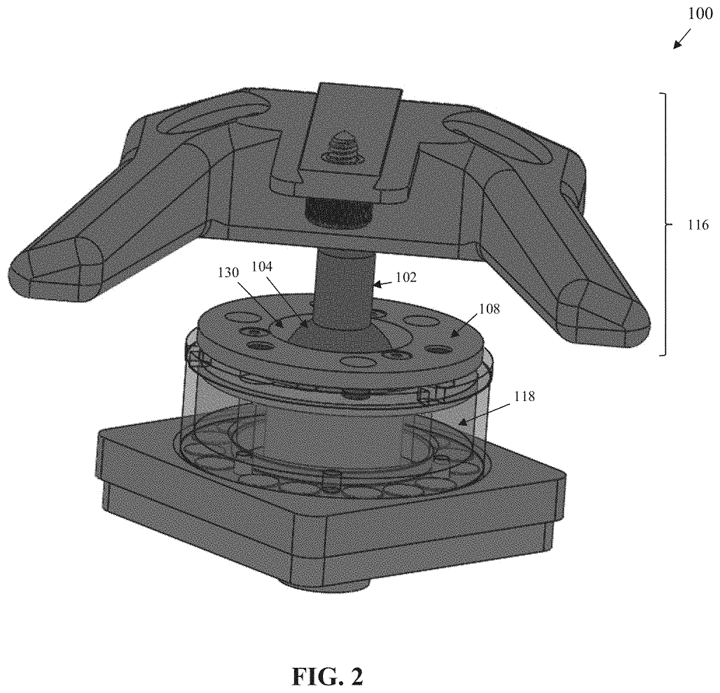

Armature plate 108 may be positioned around the opening of chamber 122 of base 106. Any number of adjustment screws 110, such as screws 110a-110b shown, may extend through armature plate 108, thereby coupling armature plate 108 to the top surface of base 106 and retaining curved end 104 of shaft 102 within chamber 122. More specifically, and as shown in greater detail in FIG. 2, armature plate 108 may define an aperture 130 through which shaft 102 extends. Generally, aperture 130 of armature plate 108 may have a diameter that is less than that of curved end 104, so as to ensure that shaft 102 cannot be removed from ball joint 100 when armature plate 108 is fastened to base 106 via adjustment screws 110. When tightened, adjustment screws 110 may cause armature plate 108 to provide a default amount of compressive force to the curved end of shaft 102. A preferred embodiment of an adjustment screw 110 is a shoulder bolt, which provides a smooth surface over which armature plate 108 can move. Thus, the configuration shown allows for the device 116 coupled to shaft 102 to be positioned with three degrees of freedom, during use.

As would be appreciated, the maximum amount of movement afforded to device 116 in any particular direction by ball joint 100 may be a function of the diameter(s) of shaft 102, the diameter of aperture 130 of armature plate 108, and the amount of compressive force exerted on curved end 104 of shaft 102 by armature plate 108.

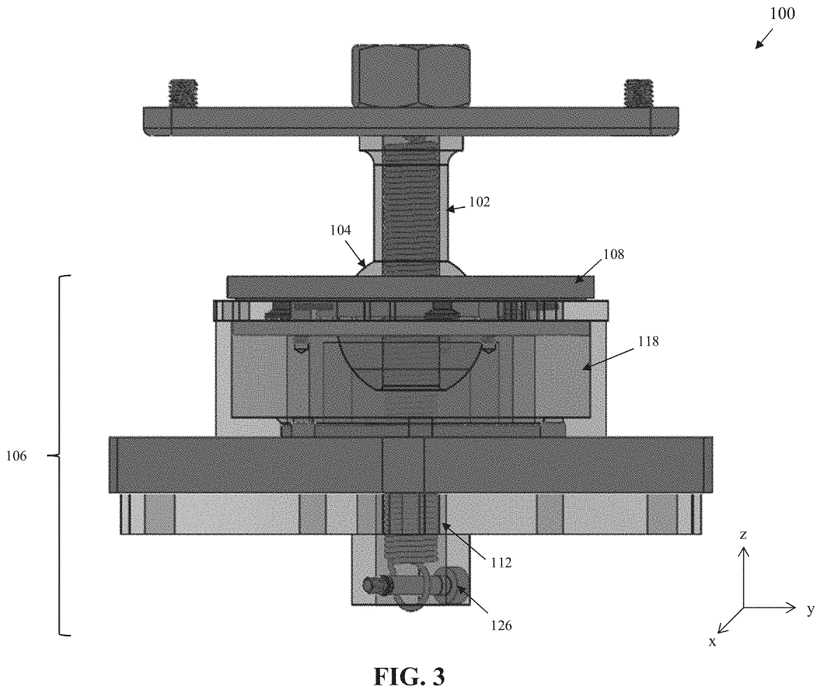

As shown in FIGS. 1 and 3, a spring 112 may extend through base 106 and into shaft 102. In various embodiments, one end of spring 112 may be coupled to base 106 and the opposing end of spring 112 may be coupled to shaft 102 via a similar fastening mechanism. When coupled to both base 106 and shaft 102, spring 112 may provide a counter force against any rotational force applied to shaft 102 about the z-axis shown.

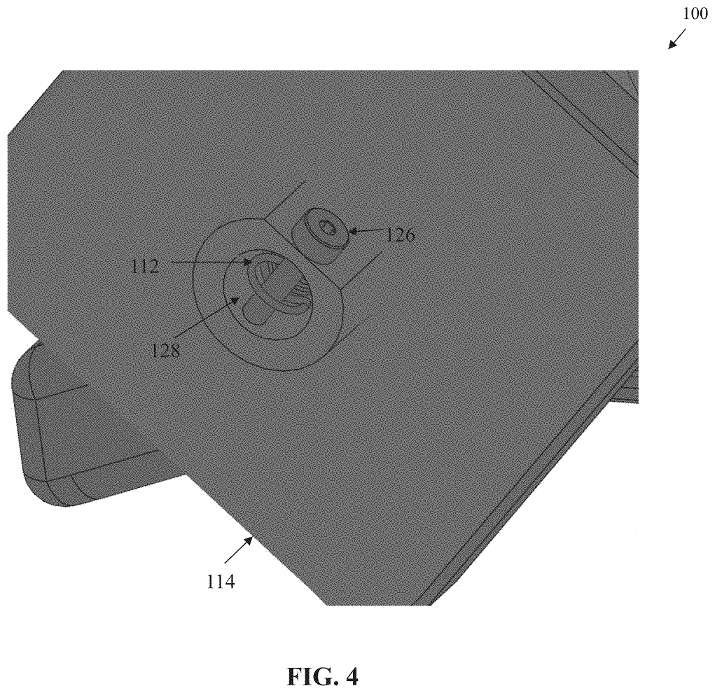

By way of example, FIG. 4 shows bottom surface 114 of base 106 of ball joint 100. As shown, surface 114 may define an aperture 128 that extends through base 106 to chamber 122 of base 106. In some instances, aperture 128 may take the form of a protrusion through which a fastener 126 may extend. For example, fastener 126 may take the form of a bolt, rod retained within aperture 128 via a cotter pin, or the like. The end of spring 112 may form a loop through which fastener 126 may extend, thereby coupling the end of spring 112 shown to base 106. A similar fastening mechanism may be used on the opposing end of spring 112, to couple spring 112 to shaft 102.

Referring again to FIG. 1 and as described in greater detail below, spring 112 may provide an internal channel for one or more wires that extend from device 116 through shaft 102 and base 106. For example, power cabling, optical fibers, or other cabling of device 116 may extend through spring 112. In such cases, the counter force against any rotational force applied to shaft 102 about the z-axis will prevent the cable(s) extending through spring 112 from becoming twisted over time.

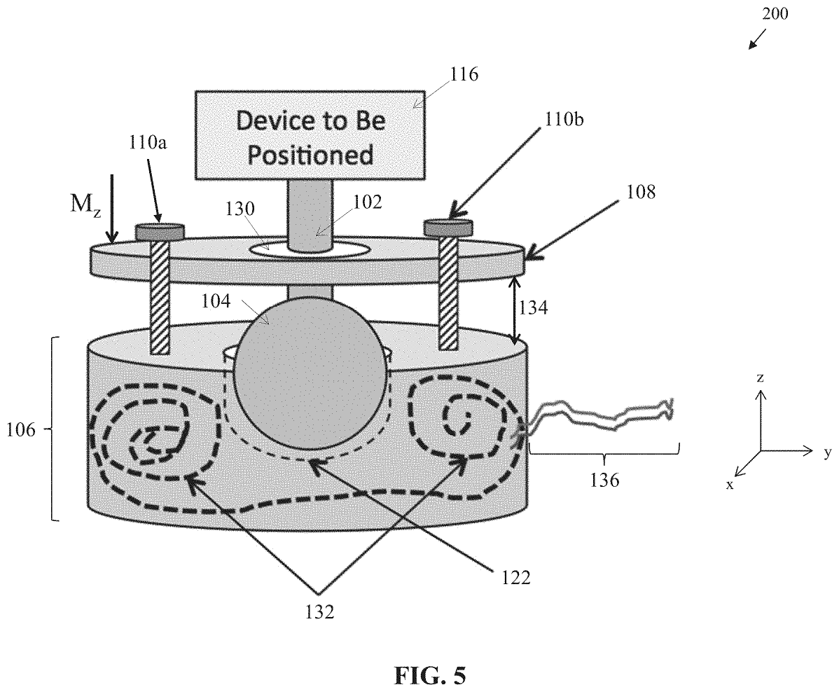

In various embodiments, internal to base 106 may be an electromagnet 118 configured to lock the position of shaft 102 in ball joint 100 when actuated. To better describe the operation of electromagnet 118, FIG. 5 shows a schematic diagram 200 of the ball joint 100 shown in FIGS. 1-4. As shown, electromagnet 118 may comprise any number of conductive coils 132 that are powered by positive and negative brake leads 136 (e.g., conductive wires).

Generally speaking, coil(s) 132 of electromagnet 118 may lie substantially along the x-y plane shown. Thus, when energized with one polarity, coil(s) 132 may exert a magnetic force M_{z} onto armature plate 108, which may be partially or fully composed of a material that experiences a magnetic force when in the presence of a magnetic field. For example, armature plate 108 may comprise a ferromagnetic material, in some cases. Conversely, when coil(s) 132 are energized with the opposite polarity, coil(s) 132 may exert a magnetic force of magnitude M along the z-axis, thereby repelling armature plate 108 away from base 106.

In a preferred embodiment, the magnetic force of electromagnet 118 is “always on.” Thus, when no energy is applied to the brake, armature plate 108 is attracted to electromagnet 118 and shaft 102 is locked. When forward polarity is applied, the electromagnetic force is dissipated (but not repelled) and armature plate 108 is free to move. In this mode, adjustment screws 110 will prevent armature plate 108 from falling off and taking shaft 102 with it. When reverse polarity is applied, the amount of attractive force is effectively doubled from that when no power is applied at all. Alternatively, the reverse situation can also be implemented, in further embodiments, whereby ball joint 100 uses a brake that is normally off when no power is applied. However, this embodiment would also require more power consumption, as electromagnet 118 would need to be powered to hold shaft 102 in place.

Accordingly, control of the current through the coil(s) 132 of electromagnet 118 via brake leads 136 in base 106 provides for three modes of operation:

1.) No Current Applied—In this mode of operation, a default amount of compressive force is applied to curved end 104 of shaft 102 by the adjustment screws 110, thereby compressing armature plate 108 towards base 106. In doing so, the portion of armature plate 108 around aperture 130 through which shaft 102 extends may translate the force to the curved end 104 of shaft 102. Depending on the settings of the screws 110, the default force may prevent all motion of curved end 104. Notably, the settings of adjustment screws 110 may control the maximum possible gap 134 between armature plate 108 and base 106, when no current is applied to coil(s) 132. In other embodiments, the default force may allow for some movement of shaft 102, but with resistance, or may even be non-existent, so as to allow the full range of motion of shaft 102 and its curved end 104, by default.

2.) Current Applied with Polarity 1—In this mode of operation, a current is applied to the coil(s) 132 via brake leads 136, thereby exerting an attractive force onto armature plate 108 and resulting in a compressive force being applied to curved end 104 of shaft 102 located between armature plate 108. This compressive force may, in some cases, be additive to the default force from the adjustment screws 110. For example, applying current to coil(s) 132 in this manner may double the amount of compressive force onto the curved end 104 of shaft 102, thereby securely locking the position of shaft 102.

3.) Current Applied with Polarity 2—In this mode of operation, a current is applied to coil(s) 132 with the opposite polarity as that of Polarity 1 above. As such, the magnetic force applied to armature plate 108 is also reversed, resulting in a repulsive force between base 106 and armature plate 108. In cases in which adjustment screws 110 provide at least some compressive force to curved end 104 sandwiched between armature plate 108 and chamber 122 of base 106, the amount of repulsive force may be configured to exceed the compressive force of screws 110 and allow full motion of shaft 102 with three degrees of freedom. Of course, in other embodiments, the amount of repulsive force from coil(s) 106 can be configured such that at least some compressive force is still applied to curved end 104 of shaft 102, resulting in at least a little bit of resistance when positioning shaft 102, manually.

In further embodiments, curved end 104 of shaft 102 may itself also comprise a ferromagnetic material and coil(s) 132 of base 106 may be sized and positioned to exert a magnetic force onto curved end 104 of shaft 102, in addition to that of armature plate 108. For example, coil(s) 132 may be located under and/or along the sides of chamber 122 engaged by curved end of shaft 102.

In yet another embodiment, chamber 122 of base 106, curved end 104 of shaft 102, and/or armature plate 108 may have a coefficient of friction among one another to provide at least some resistance against any attempts to reposition shaft 102 within ball joint 100. In some cases, chamber 122, curved end 104 of shaft 102, and/or armature plate 108 may be coated with a high friction coating material. In further cases, chamber 122, curved end 104 of shaft 102, and/or armature plate 108 may be manufactured so as to exhibit a desired degree of friction. For example, chamber 122, curved end 104 of shaft 102, and/or armature plate 108 may comprise materials that provide a desired level of friction or may be formed with texturing, to provide the desired degree of friction.

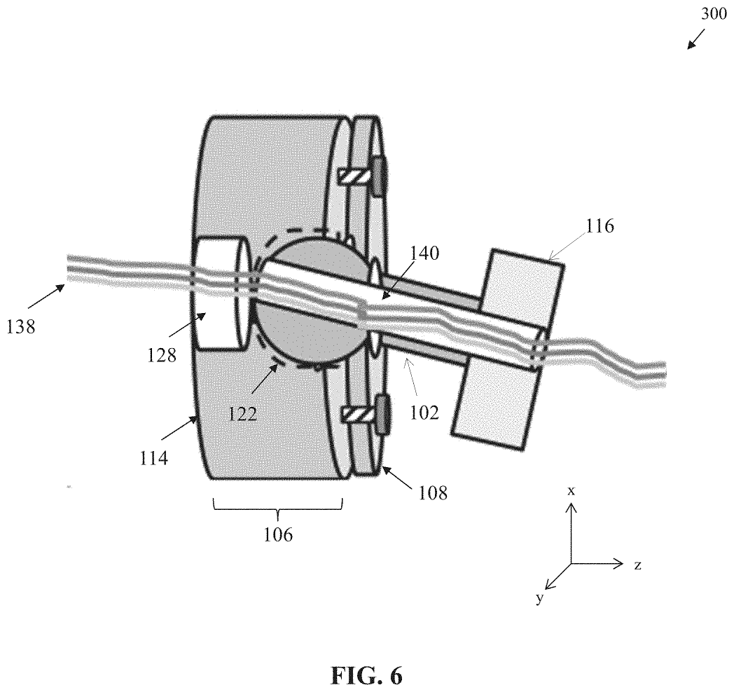

FIG. 6 shows another schematic diagram 300 of ball joint 100 of FIGS. 1-4, to illustrate the embodiments of ball joint 100 in which one or more cables 138 may extend through ball joint 100 to payload device 116. In some embodiments, aperture 128 may extend from a bottom surface 114 of base 106 to chamber 122 of base 106. Also, as shown, shaft 102 may define an aperture 140 that extends throughout the length of shaft 102 (e.g., shaft 102 may be hollow).

Typically, aperture 128 at chamber 122 may be of a larger diameter than that of aperture 140 that extends through shaft 102, allowing the two to maintain a channel through which cable(s) 138 may extend, regardless of how shaft 102 is currently positioned. As noted above, a spring (e.g., spring 112 described previously) may extend substantially along the walls of the channel formed by apertures 128 and 140, to prevent cable(s) 138 from becoming twisted as a result of too much rotation of shaft 102.

Accordingly, the techniques introduce a ball joint with an electronic braking mechanism. In one mode of operation, the ball joint allows for a device coupled to the ball joint to be positioned as desired, with up to three degrees of freedom. Providing current to one or more conductive coils of an electromagnet in the base of the ball joint then either releases the ball joint for positioning of the device or, alternatively, locks the shaft of the ball joint into its current position.

As will be appreciated, the above examples are intended only for the understanding of certain aspects of the techniques herein and are not limiting in nature. While the techniques are described primarily with respect to a particular device or system, the disclosed processes may be executed by other devices according to further implementations. For example, while the techniques herein are described primarily with respect to positioning a medical imaging device, the techniques herein are not limited as such and can be adapted for use in other industries, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. For example, control of the current to the housing coil(s) may be computer controlled, in some embodiments. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A ball joint comprises:
a base that includes:
a first surface that defines a hemispherical chamber, and
an electromagnet located internal to the base;
an armature plate fastened to the first surface of the housing and defining an aperture that extends through the armature plate towards the hemispherical chamber; and
a shaft that extends through the aperture of the armature plate and has a rounded end that engages the hemispherical chamber of the housing and, wherein powering the electromagnet draws the armature plate towards the first surface to provide compressive force to the shaft and prevents movement of the shaft.

2. The ball joint as in claim 1, further comprising:
a plurality of adjustment screws that extend through the armature plate and fasten the armature plate to the first surface of the housing.

3. The ball joint as in claim 2, wherein adjustment of the adjustment screws controls a maximum possible gap between the armature plate and the housing.

4. The ball joint as in claim 1, wherein the base further comprises a second surface opposite the first surface and defines an aperture that extends through the base from the second surface to the hemispherical chamber of the second surface.

5. The ball joint as in claim 4, wherein the shaft defines an internal aperture that extends from the rounded end of the shaft through the shaft.

6. The ball joint as in claim 5, further comprising:
one or more cables that run through the aperture of the base and the aperture of the shaft.

7. The ball joint as in claim 5, further comprising:
a spring that extends through the aperture of the base and the aperture of the shaft, wherein the spring restricts a range of rotation of the shaft.

8. The ball joint as in claim 1, wherein the electromagnet comprises a coil of wire located about an axis that extends through the aperture of the armature plate.

9. The ball joint as in claim 1, further comprising:
a payload device affixed to the shaft and located opposite the rounded end of the shaft.

10. The ball joint as in claim 9, wherein the payload device comprises a medical imaging device.

11. The ball joint as in claim 1, wherein the armature plate comprises a ferromagnetic material.
